(19) United States
(12) Patent Application Publication
(10) Pub. No.: US 2006/0005703 A1
(43) Pub. Date: Jan. 12, 2006

(54) Ultraviolet air purifier having multiple charged collection plates

(76) Inventor: Chi-Hsiang Wang, Taipei (TW)

Correspondence Address: Loletta L. Darden;Sachnoff & Weaver, Ltd., 10 S. Wacker Drive, Chicago, IL, 60606-7507, US

(21) Appl. No.: 11/171,030

(22) Filed: Jun. 30, 2005

Related U.S. Application Data
(60) Provisional application No. 60/584,192, filed on Jun. 30, 2004.

(51) Int. Cl. B03C 3/38

(52) U.S. Cl. 95/58; 96/16; 96/224; 422/24; 422/121

(57) ABSTRACT

An air cleaning device has a housing with at least one input aperture and at least one output aperture, and an air channel therebetween. A first collection plate has a first wall with first inside edges and first outside edges, and has a first charge applied thereto. A second collection plate has a second wall with second inside edges and second outside edges, and has a second charge applied thereto. The second collection plate is housed in a first space between the first inside edges of the first collection plate. A third collection plate has a third charge applied thereto. The third collection plate is housed in a second space between the second inside edges of the second collection plate. A set of charged wires are located outside the first collection plate so as to create an electrostatic field within the housing. The electrostatic field ionizes incoming air. A fan creates a flow of air into the at least one input aperture and out the at least one output aperture.

### RELATED APPLICATION

This application claims priority to Provisional Patent Application Ser. No. 60/584,192, entitled Ultraviolet Art Purifier Having Multiple Charged Collection Plates, filed Jun. 30, 2004.

### BACKGROUND

1. Technical Field

The invention relates to air purifiers, and more specifically, to air purifiers utilizing multiple charged collection plates and a germicidal light to clean air circulating through the air purifier.

2. Description of the Related Arts

There are air purifiers known in the art. For example, one model made by Sharper Image uses electro-kinetic energy to cause air to circulate through the air purifier. The model includes an electro-kinetic transducer to convert energy into ion flow, causing the air to flow through the air purifier. Such model also includes a germicidal Ultraviolet (“UV”) lamp to clean the air. This type of air purifier creates an electrostatic field and polarizes air entering into the purifier. Air enters through the bottom of the air purifier, and circulates up through the purifier and out an opening near the top of the purifier. As the air flows upward within the air purifier, it passes the germicidal UV lamp, which kills some bacteria within the flowing air. This model employs a single electrostatic field and a single air filter. Particles attach themselves only to the outside edge of the air filter.

Another air purifier model is made by Honeywell. In the Honeywell model, air enters the air purifier at a location near the bottom and exits at a location near the top. This model includes a single air filter. The air stream within the purifier is subjected to a single electrostatic field, generated by a wire on a single surface within the purifier, and particles within the air stream attach themselves only to the outside edge of the air filter.

### SUMMARY OF THE INVENTION

One embodiment of the invention is directed to an air cleaning device which has a housing having at least one input aperture and at least one output aperture, and an air channel therebetween. A first collection plate has a first wall with first inside edges and first outside edges, and has a first charge applied thereto. A second collection plate has a second wall with second inside edges and second outside edges, and has a second charge applied thereto. The second collection plate is housed in a first space between the first inside edges of the first collection plate. A third collection plate has a third charge applied thereto. The third collection plate is housed in a second space between the second inside edges of the second collection plate. A set of charged wires are located outside the first collection plate so as to create an electrostatic field within the housing. The electrostatic field ionizes incoming air. A fan creates a flow of air into the at least one input aperture and out the at least one output aperture.

### BRIEF DESCRIPTION OF THE DRAWINGS

FIG. 1 illustrates a side view of an air purifier according to an embodiment of the invention;

FIG. 2 illustrates a front view of the air purifier according to an embodiment of the invention;

FIG. 3 illustrates a view of the top of the air purifier according to an embodiment of the invention;

FIG. 4 illustrates an exploded diagram of a small air collection plate, a medium-sized air collection plate, and a large collection plate according to an embodiment of the invention;

FIG. 5 illustrates a partial cross-section area of the air purifier, illustrating a cross-section of all components between the large collection plate and the outer wall of the main body according to an embodiment of the invention;

FIG. 6 is a cross-sectional block diagram of half of the air purifier according to an embodiment of the invention;

FIG. 7 illustrates an exploded diagram of the air purifier according to an embodiment of the invention;

FIG. 8 illustrates a cross-sectional view of the air purifier according to an embodiment of the invention; and

FIG. 9 illustrates a method of cleaning air according to an embodiment of the invention.

### DETAILED DESCRIPTION

The invention is directed to an air purifier. In the most general form, the air purifier includes a housing that retains a fan or blower, an ionization unit, a permanent filtration assembly, and a germicidal ultraviolet (UV) lamp.

In operation, the fan or blower draws air into and forces air circulation through the housing. This forced air circulation creates a suction that draws additional air into the air purifier through one or more inlet ports and a back pressure that forces the air out of the air purifier though one or more discharge ports.

The air purifier includes three collection plates for trapping particles within the air. The three collection plates may each be formed of a conductive material such as aluminum. The three collection plates may have different sizes—a small collection plate may be housed between the walls of a medium-sized air collection plate, and the medium-sized collection plate may in turn be housed between the walls of a large collection plate. The walls of the large collection plate may be negatively charged, the walls of the medium-sized collection plate may be positively charged, and the walls of the small collection plate may be negatively charged.

When air is drawn into the air purifier, it passes by the ionization unit. The ionization unit creates a charged electrostatic field that ionizes the air molecules and particulate matter entrained therein. The ionization process results in negative and positive ions and neutral-charged molecules and particles.

The removable permanent filtration assembly comprises one or more charged collection plates for collecting oppositely charged ions and particles that flow through the air purifier. The collection plates may be positioned adjacent, concentric or contiguous to one another. The collection plates may also be positioned and charged such that a negatively charged plate is adjacent, concentric or contiguous to a positively charged plate or vice versa. This arrangement permits at least one collection plate of the permanent filtration assembly and the ionization unit to trap charged particles shortly after the air stream enters the air purifier. For example, some of the charged ions and particles may be attracted to and stick onto the closest oppositely charged collection plate. Likewise, some of the charged ions and particles may be attracted to and stick onto the ionization unit if oppositely charged. The rest of the air, i.e., neutral particles, molecules and charged particles that are not trapped by the ionization unit or the collection plate, is forced up to the top of the air purifier.

In one embodiment, as the air is forced upward, UV light from a germicidal UV lamp irradiates the air stream with UV light rays. The ultraviolet lamp neutralizes certain airborne bacteria, mold and viruses another particles entrained therein. Once at the top of the air purifier, the air is then forced back down the air purifier and is eventually forced out of the housing through the discharge port.

As the air flows back downward, UV light from the germicidal lamp continues to shine on the air, destroying or diminishing the amount of bacteria or other particles in the air. Also, charged particles in the air may attach themselves to one or more of the collection plates. Once at the bottom of the air purifier, a fan blows the cleaned air out of the air purifier.

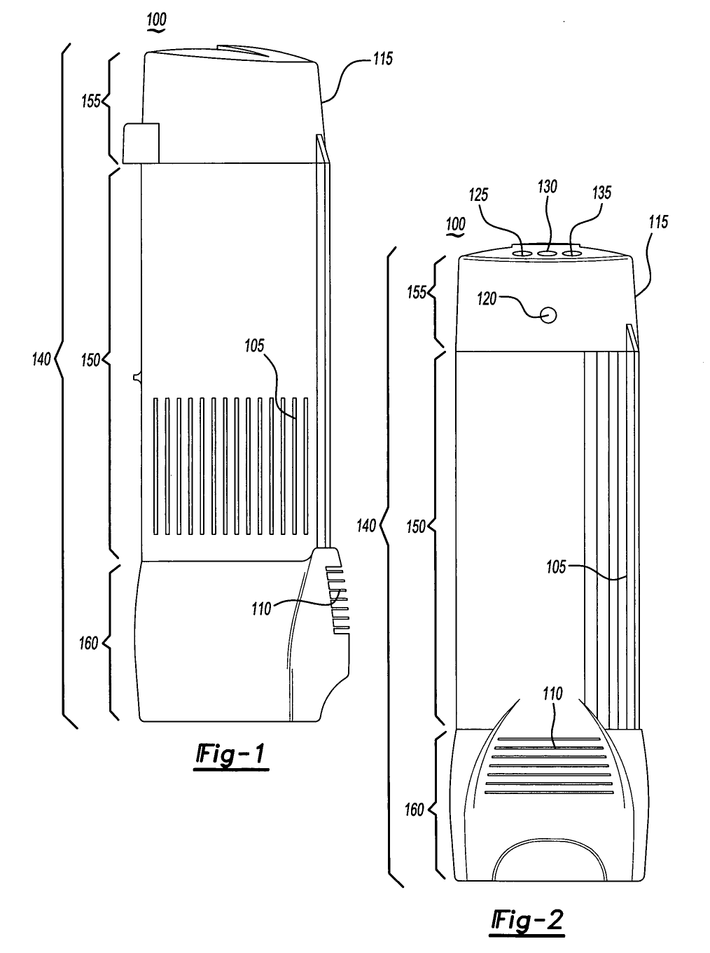

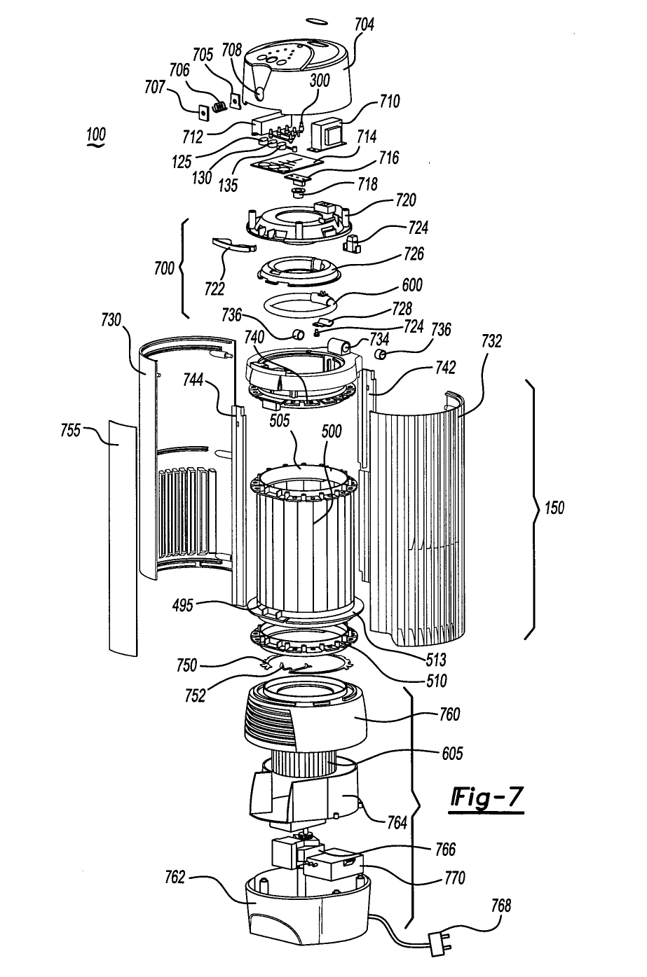

Turning now to an illustrated embodiment of the invention, FIG. 7, shows an exploded of an air purifier 100 designed in accordance with the teaching of this invention. As best seen in FIGS. 1, 4 and 7, the air purifier 100 includes a housing 115 that retains a fan or blower 605, an ionization unit 495, a permanent filtration assembly 395, and a germicidal UV lamp assembly 700.

FIG. 1 illustrates a side view of an air purifier 100. The air purifier 100 may be powered by AC power from a standard AC outlet; in other embodiments, the air purifier 100 may be powered from a DC power source such as batteries.

As best seen in FIG. 1, the housing 115 may have a generally cylindrical shape, and may be formed of a material such as a hard plastic. The housing 115 may be comprised of three sections—a top section 155, a main body 150, and a base portion 160. The main body portion 150 defines one or more inlet apertures 105. As shown in FIG. 1, the inlet apertures 105 may be located on the bottom half of the main body 150, each of which may extend in a vertical direction. The inlet apertures 105 may be located at a plurality of locations wrapping around the cylindrical shape of the housing 115, so as to draw in air from substantially all directions.

The housing 115 also defines one or more outlet apertures 110. As best seen in FIG. 1, the outlet apertures 110 may be formed on the base formed on the 160 at a position below the inlet apertures 105.

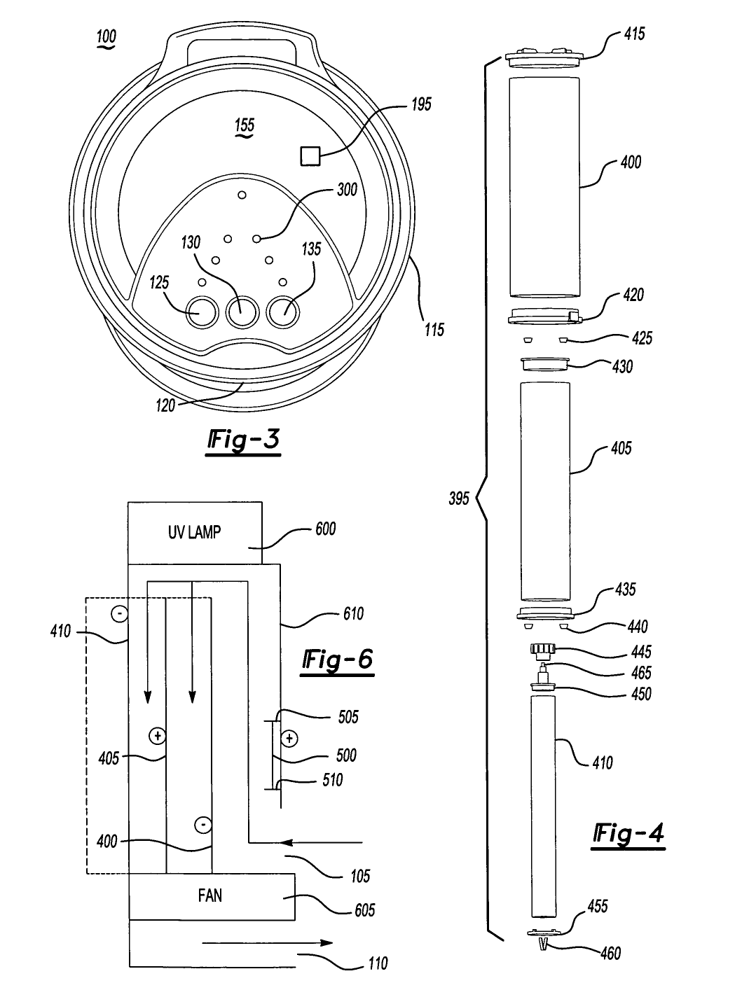

FIG. 2 illustrates a front view of the air purifier 100. As best seen in FIGS. 2 and 3, the top section 155 may support a power button/switch 130 for activating the air purifier 100. For example, the power button/switch 130 may be depressed to active the air purifier 100. The top section 155 may also support a speed control button/switch 135. The speed control button/switch 135 permits the air purifier 100 to operate at three different speeds. For example, the speed control button/switch 135 may be depressed once to initiate a “slow speed” setting, twice to initiate a “medium speed” setting, and three times to initiate a “fast speed” setting. In other embodiments, the air purifier 100 may operate at more or fewer than three speeds. The top section 155 may also support an auto-off timer function to shut off the unit after increments of time such as, e.g., 2-hr, 4-hr, or 8-hr. The auto-off timer function may be implemented by a timer button/switch 125 and timing control circuitry within the air purifier 100. The top section 155 supports a depressible button 120 which, when depressed, allows the top of the air purifier 100 to be opened, thus permitting access to components located within the housing 115.

As best seen in FIG. 3, the top surface of the top section 155 supports light indicating devices 300 such as Light Emitting Diodes (“LEDs”). The light indicating devices 300 may be lit during operation to indicate that the air purifier 100 is turned “on” and is operating properly. The top surface of top section 155 may also support a UV on/off button/switch 195 to activate or turn off the germicidal UV lamp.

FIG. 4 illustrates an exploded diagram of a small collection plate 410, a medium-sized collection plate 405, and a large collection plate 400 for trapping particles entrained in the air stream. The three collections plates 400, 405, and 410 may be arranged such that the small collection plate 410 may be housed between the walls of the medium-sized collection plate 405, and the medium-sized collection plate 405 may in turn be housed between the walls of the large collection plate 400. The three collection plates 400, 405, and 410 may each be formed of a conductive material such as aluminum.

As best seen in FIG. 6, the walls of the collection plates 400, 405 and 410 may support an electric charge. For example, the walls of the large collection plate 400 may be negatively charged, the walls of the medium-sized collection plate 405 may be positively charged, and the walls of the small collection plate 410 may be negatively charged. Air circulating within the air stream through the air purifier 100 may contain charged particles such as dust. A function of the air purifier 100 is to remove these charged particles from the air stream by attracting the particles to the charged collection plates 400, 405, and 410.

The collection plates 400, 405, and 410 may be cleaned by opening up the air purifier 100 by rotating the top section 155 (FIG. 2) and reaching in and pulling out the collection plates 400, 405, and 410 residing within the main body 150. Each of the collection plates 400, 405, and 410 may then be wiped with a damp cloth to remove dust and other particles stuck attached thereto. Tap water may be utilized to moisten the cloth. After sufficient drying time, the collection plates 400, 405, and 410 may be reinserted.

As best seen in FIG. 4, the collection plates 400, 405 and 410 may be cylindrically shaped and concentrically arranged. One advantage of the cylindrical shape of the collection plates 400, 405 and 410 is that an increased surface area is provided for particle collection. For example, test results for one embodiment of the air purifier 100, report that the cylindrically shaped collection plates 400, 405 and 410 provide approximately five times the particle collection surface area and traps approximately two times the pollutants captured by leading air purifiers that use a flat metal sheet as the particle collector.

Turning now to FIG. 4, the large collection plate 400 has a large cover 415 that fits on the top end of the large collection plate 400. A large holder 420 and a set of connectors 425 are used to secure the large collection plate 400 to the main body 150 near the bottom of the main body 150. The medium-sized collection plate 405 has a medium-sized cover 430 that fits on the top end of the medium-sized collection plate 405. A medium-sized holder 435 and a set of connectors 440 are used to secure the medium-sized collection plate 405 to the main body 150 near the bottom of the main body 150. The small collection plate 410 has a small cover 450 which fits on the top end of the small collection plate 410. A small holder 455 and a connector 460 are used to secure the small collection plate 410 to the main body 150 near the bottom of the main body 150. A handle 445 is attachable to the small collection plate cover 450. When the small collection plate 410 is placed within the medium-sized collection plate 405 and the medium-sized collection plate 405 is placed within the large collection plate 400 and the entire combination of collection plates 400, 405, and 410 is placed inside the main body 150 and secured, a knob 465 on the small collection plate cover 450 may extend up through the medium-sized cover 430 and the large cover 415. The handle 450 may be screwed onto the knob 465, or attached thereto is some other manner, so as to secure the collection plates 400, 405, and 410 to each other.

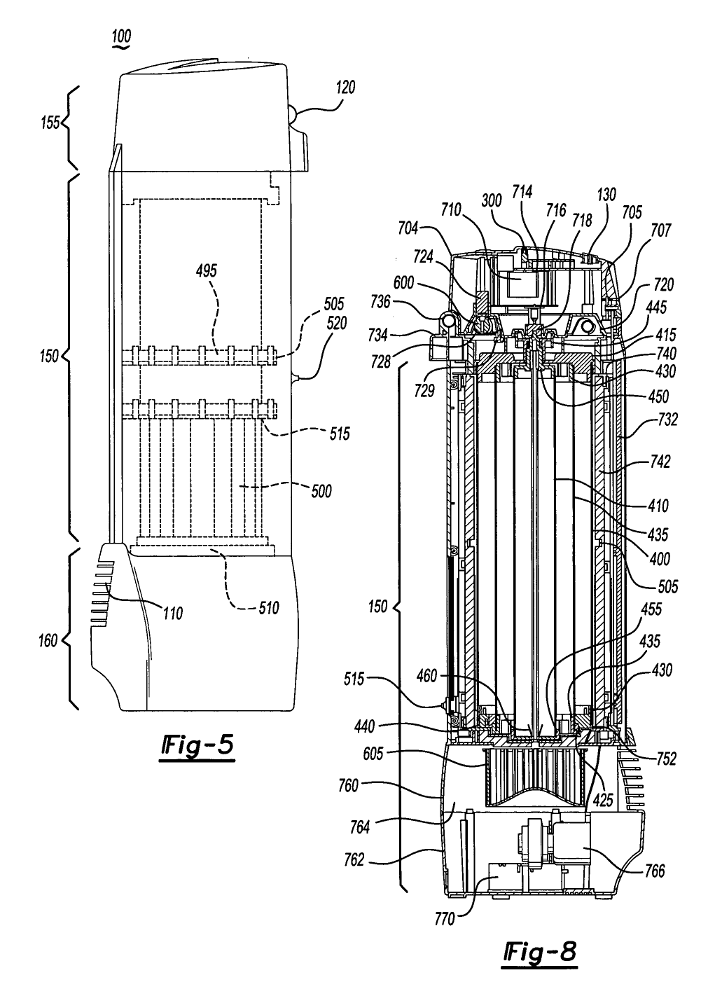

FIG. 5 illustrates a partial cross-sectional area of the air purifier 100, illustrating a cross-section of all components between the large collection plate 400 and the outer wall of the main body 150. As illustrated, the ionization unit 499 may include a set of wires 500 that extend vertically between two support plates identified in FIG. 5 as a middle plate 505 and a lower plate 510. The wires 500 may be substantially evenly spaced around the circumference of the air purifier 100. When an electric charged is supplied to the wires 500, a more uniform electrostatic field may be generated than would be possible if the wires 500 did not extend around the circumference or were only coupled to a single surface.

The wires 500 may be formed of tungsten, for example. Specifically, the wires 500 may be formed of stainless tungsten, and in other embodiments, the wires 500 may be formed of tungsten coated with gold, or any other suitable conductive material. The middle plate 505 and the lower plate 510 may each be formed of a metal material such as aluminum or stainless steel, for example.

As best seen in FIG. 7, a scraper 515 may also be positioned parallel to the middle plate 505 and the lower plate 510. The scraper 515 may include a support plate that defines a plurality of apertures. Each aperture may be sized to receive of the wires comprising the wires 500. The scraper 515 may also include a member 520 for cleaning the wires 500. For example, the member 520 may be movably attached to a portion of the scraper 515 using known techniques such that the member 520 is accessible on the exterior surface of the air purifier 100. By pushing down or pulling up on the member 520, a user may move the scraper 515 in upward and downward directions. For example, moving the scraper 515 permits cleaning of the wires 500, i.e., the removal of dust and other particles that periodically attach themselves to the wires 500.

Once the air arrives up near the germicidal lamp 600, it flows back down via one of two pathways. For the described embodiment, the first pathway is between the inside edge of the negatively charged large collection plate collection plate 400 and the outside edge of the positively charged medium-sized collection plate collection plate 405. The second pathway is between the inside edge of the positively medium-sized collection plate collection plate 405 and the outside edge of the negatively charged small collection plate collection plate 410. As the air flows down on of these paths, negatively charged particles in the air attached themselves to the positively charged medium sized collection plate collection plate 405 and positively charged particles in the air attached themselves to either the inner edge of the large collection plate collection plate 400 or the outside edge of the small collection plate collection plate 410. The collection plates 400, 405, and 410 may receive their respective charges from the base 160 of the air purifier 100, where they may be secured.

Once the air reaches the bottom of the collection plates 400, 405, and 410, a fan 605 blows the air out of the outlet aperture 110 and back into the area in which air is being cleaned. When the fan 605 blows air out of the outlet aperture 110 of the air purifier 100, new air is drawn into the inlet aperture 105 by the resulting suction.

Referring again to FIG. 7, this figure illustrates an exploded diagram of the air purifier 100, and more particularly the germicidal UV lamp assembly 700. The UV lamp assembly 700 includes a UV lamp 600 supported with a UV reflector 726 using conventional techniques. The UV reflector 736 is supported with a top bottom 720, wherein the top bottom 720 is coupled to the top cover 704. For instance, the top bottom 720 may be coupled to the top cover 704 via screws. Additionally, a UV lens 722 and a UV jack 724 are positioned between the reflector 726 and the top bottom 720.

The UV assembly 700 also includes a lamp holder 728 positioned directly below the UV lamp 600. The lamp holder 728 may be held in place by a holder screw 729. The UV assembly 700 also includes a transformer 710 and a UV inverter 712 located beneath the top cover 704. The UV lamp 600 requires a relatively high frequency to start; the UV inverter 712 supplies this high frequency. The UV assembly 700 also include safe knob 718 that may be utilized to prevent power from reaching the germicidal UV lamp 600 when the light bulb is being replaced.

Referring to FIGS. 2 and 7, to insert or replace the germicidal UV lamp within the air purifier 100, the air purifier 100 may be “opened up” by rotating the top section 155 along the hinge, exposing the internal components within the body of the air purifier 100. The UV lamp 600 may then be removed.

FIG. 7 also provides additional detail regarding the button 120 previously discussed with respect to FIG. 2. The button 120, which allows the user to open up the top portion 155 of the air purifier, may be comprised of a locking piece 707, a spring 706 and a fix plate 705. The button 120 may be located within an aperture 708 on the top cover 704.

FIG. 7 further illustrates that the light emitting devices 300, the speed button/switch 135, the power button/switch 130, and the timer button/switch 125 may be located beneath the top cover 704. The light emitting devices 300 may be mounted on a main printed circuit board (“PCB”) 714, which may be coupled to a power PCB 716.

FIG. 7 also illustrates further detail concerning the housing 115. The main body 150 of the housing 115 may include a left enclosure 730 and a right enclosure 732, which together form the outside wall of the air purifier 100. A unit top 734 may include a hinge 736 coupled to the top cover 704, that allows the top cover 704 to swivel open. A supporter 742 may be coupled to the unit top 734 and may be coupled to a support groove 744 on the left enclosure 730. In other embodiments, the support groove 744 may be located on the right enclosure 732. Directly beneath the unit top 734 is an upper plate 740. Below the upper plate 740, the middle plate 505, the wires 500, the scraper 515, and the lower plate 510 may be located. Beneath the lower plate 510 may be a line holder 750 which is used to position each of the wires 500. A touch plate 752 may be utilized to provide the charges for each of the collection plates 400, 405, and 410. A panel 755 attaches between the left enclosure 730 and the right enclosure 732 on the front of the main body 150.

A base top 760 and a base bottom 762 comprise the base portion 160. The blower/fan 605 is located between the base top 760 and the base bottom 762. The fan 605 may be a centrifugal fan of the type commonly used in air purifiers. The fan 605 circulates the air inside the housing 115 along a nonlinear flow path.

Using the fan 605 to circulate the air through the housing 115 results in an increased clean air delivery rate (CADR) as compared to leading air purifiers that do not use fan/blower air circulation devices. Table 1 reports the CADR for one embodiment of the air purifier 100. As shown by Table 1, the CADR for the air purifier 100 for the smoke and dust is greater than twice that of leading air purifiers that do not include fan/blower circulation devices, and the CADR for pollen exceeds that of leading air purifiers that do not use fan/blower circulation devices.

TABLE 1
CADR for an Embodiment of Air Purifier 100

| POLLUTANT | CADR |
|---|---|
| Smoke | 38.2 |
| Dust | 39.5 |
| Pollen | 38.7 |

Additionally, the fan permits greater air circulation through the unit. Test data for one embodiment of the air purifier 100 reports an air circulation rate of 50 CFM compared to 17 CFM for leading air purifiers that do not use fan/blower air circulation devices. Further, test results for one embodiment of the air purifier 100 report an air clean time of approximately 21 minutes for a standard size room as compared to 61 minutes for leading air purifiers that do not use fan/blower air circulation devices.

The fan 605 may be coupled to a motor housing 764 and a motor 766. The motor 766 is powered by either a high voltage power supply 770 or power from an electrical outlet via power cord 768. The motor 766 may include a muffler to quiet the motor 766 during operation.

FIG. 8 illustrates a cross-sectional view of the air purifier showing the placement of the large collection plate 400, the medium-sized collection plate 405, and the small collection plate 410 within the air purifier 100 when the top cover 704 in secured to the main body 150. FIG. 8 illustrates the locations of the assembled components shown in the exploded assembly diagram of FIG. 7.

As best illustrated in FIG. 6, in one embodiment, the air purifier 100 cleans air drawn into the housing 115 in various stages. For example, air enters the air purifier 100 via the inlet aperture 105. Once inside the air purifier 100, the air encounters the positively charged electrostatic field generated by the wires 500. After encountering the positively charged electrostatic field, the air becomes ionized, creating positive, negative and neutral particles. Some of the positively charged particles attach to the outside of the negatively charged collection plate 400 and some of the negatively charged particles attach to the positively charged wires 500. The rest of the air is drawn up to the top of the air purifier 100, between the outer wall of the air purifier and the outside edge of the large air collection plate. Once above the top of the air large collection plate collection plate 400, the air is then drawn back down the air purifier 100.

As the air flows back downward, charged particles in the air may attach themselves to the inner edges of the negatively charged large collection plate collection plate 400, the inner or outer edges of the positively-charged medium-sized collection plate collection plate 405, or to the outer edges of the negatively-charged small collection plate collection plate 410. Once at the bottom of the air purifier 100, a fan 605 blows the cleaned air out of the air purifier 100. Upon entering the air purifier 100, the air flow path inside the air purifier 100 is non-linear and involves several sharp angular turns as best seen in FIG. 6.

As best seen in FIG. 6, upon entering the air purifier 100, the air is drawn into the air purifier 100 along a path that is lateral to the axis of the fan 605. After passing through the ionization unit 495, the air flow turn approximately 180° and flows along the longitudinal axis of the main body portion 150 of the air purifier 100 until it reaches the top section 155. At the top section 155, the air stream makes another turn of approximately 180° and flows downward along the longitudinal axis of the main body portion 150 and into the base portion 160. At the base portion 160, the air stream makes another turn and flows along the lateral axis of the base portion 160. The air stream flows past (a) the space between the outside edge of the large collection plate and the outer wall of the air purifier 100 on the way up after entering the air purifier 100, and (b) then back down in the space between either (i) the inner edge of the large collection plate collection plate and outer edge of the medium-sized air collection plate, or (b) the inner edge of the medium-sized collection plate collection plate and the outer edge of the small air collection plate. Consequently, the air stream passes over a larger particle collecting surface area onto which charged particles may attach themselves than would be possible if only a single collection plate were used or if the air stream flowed only in a single direction.

The air is forced to flow up through a pathway formed between the outside edge of the large collection plate 400 and the outer wall 610 of the air purifier 100. As it travels upward, the air is subjected to light from the germicidal UV lamp 600.

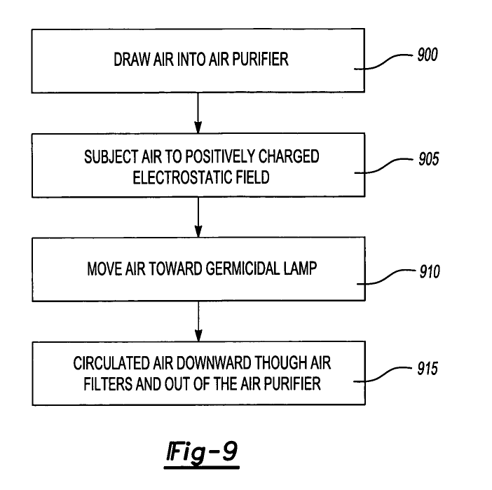

FIG. 9 illustrates one method of cleaning air using the purifier 100 shown in FIG. 6. First, air is drawn 900 into the air purifier 100. The air is subjected 905 to a positively charged electrostatic field generated by the positively charged wires 500. The positively charged electrostatic field ionizes the air, and negatively charged particles in the air attach themselves to the positively charged wires 500, and the positively charged particles attached themselves to the outside edges of the large collection plate 400. The air moves 910 upward toward the germicidal lamp 600, and light from the germicidal lamp 600 destroys or diminishes an amount of bacteria in the air. Finally, the air is circulated 915 downward through gaps between the positively charged medium-sized collection plate 405 and each of the negatively charged large collection plate 400 and the small collection plate 410. Charged particles in the air attach themselves to these collection plates, and the rest of the air is then pushed out of the outlet aperture by the fan 605.

While the description above refers to particular embodiments of the present invention, it will be understood that many modifications may be made without departing from the spirit thereof. The accompanying claims are intended to cover such modifications as would fall within the true scope and spirit of an embodiment of the present invention. The presently disclosed embodiments are therefore to be considered in all respects as illustrative and not restrictive, the scope of an embodiment of the invention being indicated by the appended claims, rather than the foregoing description, and all changes which come within the meaning and range of equivalency of the claims are therefore intended to be embraced therein.

What is claimed is:

1. An air cleaning device, comprising:
a housing having at least one input aperture and at least one output aperture, and an air channel therebetween;
a first collection plate having a first wall with first inside edges and first outside edges, and having a first charge applied thereto;
a second collection plate having a second wall with second inside edges and second outside edges, and having a second charge applied thereto, the second collection plate being housed in a first space between the first inside edges of the first collection plate;
a third collection plate having a third charge applied thereto, the third collection plate being housed in a second space between the second inside edges of the second collection plate;
a set of charged wires located outside the first collection plate so as to create an electrostatic field within the housing, wherein the electrostatic field ionizes incoming air; and
a fan to create a flow of air into the at least one input aperture and out the at least one output aperture.

2. The air cleaning device according to claim 1, wherein the first charge is a negative charge.

3. The air cleaning device according to claim 1, wherein the second charge is a positive charge.

4. The air cleaning device according to claim 1, wherein the third charge is a negative charge.

5. The air cleaning device according to claim 1, wherein the at least one input aperture is located on the bottom half of the housing.

6. The air cleaning device according to claim 1, wherein the air drawn in via the at least one inlet aperture is subjected to the ionizing electrostatic field, and some positively-charged particles in the air attach to the first outside edges of the first collection plate and some negatively-charged particles attach to the charged wires.

7. The air cleaning device according to claim 1, further including a germicidal lamp, disposed in the housing, to emit radiation upon being energized.

8. The air cleaning device according to claim 7, wherein the germicidal lamp is located near the top of the housing, and the air flows upward toward the germicidal lamp and then downward through the housing.

9. The air cleaning device according to claim 8, wherein the air flows downward in a space selected from the group consisting of: a first space between the first inside edges of the first collection plate and the second outside edges of the second collection plate; and a second space between the second inside edges of the second collection plate and the third collection plate.

10. The air cleaning device according to claim 8, wherein some of the positively charged particles in the air attach to the first collection plate and the third collection plate, and some of the negatively charged particles attach to the second collection plate.

11. The air cleaning device according to claim 7, wherein the germicidal lamp emits ultraviolet light having a wavelength of about 254 nanometers.

12. The air cleaning device according to claim 7, wherein light from the germicidal lamp diminishes an amount of bacteria in the air.

13. The air cleaning device according to claim 7, wherein light from the germicidal lamp shines on gaps between the first outside edges of the first collection plate and the inside edges of the housing, the second outside edges of the second collection plate and the first inside edges of the first collection plate, and outside edges of the third collection plate and the second inside edge of the second collection plate.

14. The air cleaning device according to claim 1, wherein each of the first collection plate, the second collection plate, and the third collection plate have a cylindrical shape.

15. The air cleaning device according to claim 1, wherein the electrostatic field has a positive charge.

16. The air cleaning device according to claim 1, wherein the wires are positively charged.

17. A method of cleaning air, comprising:
drawing air into an air purifier via at least one inlet aperture;
subjecting the air to a electrostatic field to ionize the air;
moving the incoming air upward in a housing toward a germicidal lamp, wherein light from the germicidal lamp shines on the air once it enters the housing via the inlet aperture;
circulating the air downward away from the germicidal lamp while light from the germicidal lamp shines on the air, wherein the air flows downward in a space selected from the group consisting of: a first space between first inside edges of a first collection plate and second outside edges of a second collection plate; and a second space between the second inside edges of the second collection plate and outside edges of a third collection plate,
the first collection plate carrying a first charge, the second collection plate carrying a second charge, and a third collection plate carrying a third charge.

18. The method according to claim 17, wherein the electrostatic field has a positive charge.

19. The method according to claim 17, wherein charged wires located outside the first collection plate generate the electrostatic field.

20. The method according to claim 19, wherein when the air drawn in via the at least one inlet aperture is subjected to the ionizing electrostatic field, some positively-charged particles attach to the first outside edges of the first collection plate and some negatively-charged particles attach to the charged wires.

21. The method according to claim 17, wherein the germicidal lamp emits radiation upon being energized.

22. The method according to claim 17, wherein some of the positively charged particles attach to the first collection plate and the third collection plate, and some of the negatively charged particles attach to the second collection plate.

23. The method according to claim 17, wherein the germicidal lamp emits ultraviolet light having a wavelength of about 254 nanometers.

24. The method according to claim 17, further including diminishing an amount of bacteria in the air via light from the germicidal lamp.

25. The method according to claim 17, wherein the first charge is a negative charge.

26. The method according to claim 17, wherein the second charge is a positive charge.

27. The method according to claim 17, wherein the third charge is a negative charge.
